(19) United States
(12) Patent Application Publication
(10) Pub. No.: US 2013/0083176 A1
(43) Pub. Date: Apr. 4, 2013

(54) OVERHEAD SCANNER DEVICE, IMAGE PROCESSING METHOD, AND COMPUTER-READABLE RECORDING MEDIUM

(71) Applicant: PFU LIMITED, Kahoku-shi (JP)

(72) Inventor: Yuki KASAHARA, Kahoku-shi (JP)

(73) Assignee: PFU LIMITED, Kahoku-shi (JP)

(21) Appl. No.: 13/689,228

(22) Filed: Nov. 29, 2012

Related U.S. Application Data
(63) Continuation of application No. PCT/JP2011/060484, filed on Apr. 28, 2011.

(30) Foreign Application Priority Data
May 31, 2010 (JP) 2010-125150

(51) Int. Cl. H04N 7/00

(52) U.S. Cl. CPC H04N 7/002
USPC 348/61; 348/222.1

(57) ABSTRACT

An overhead scanner device includes an image photographing unit, and a control unit, wherein the control unit includes an image acquiring unit that controls the image photographing unit to acquire an image of a document including at least an indicator provided by a user, a specific-point detecting unit that detects two specific points each determined based on the distance from the gravity center of an indicator to the end of the indicator, from the image acquired by the image acquiring unit, and an image cropping unit that crops the image acquired by the image acquiring unit into a rectangle with opposing corners at the two points detected by the specific-point detecting unit.

### CROSS-REFERENCE TO RELATED APPLICATION

This application is based upon and claims the benefit of priority from Japanese Patent Application No. 2010-125150, filed May 31, 2010, and PCT application PCT/JP2011/060484, filed Apr. 28, 2011, the entire contents of which are incorporated herein by reference.

### BACKGROUND OF THE INVENTION

1. Field of the Invention

The present invention relates to an overhead scanner device, an image processing method, and a computer-readable recording medium.

2. Description of the Related Art

An overhead scanner in which a document is placed face-up and is photographed from above has been developed.

In order to solve a problem that because the document is pressed by hand, an image of the hand is included in an image of the document, JP-A-H06-105091 discloses an overhead scanner that determines skin color from pixel outputs and corrects a skin color area by replacing it with a white color.

JP-A-H07-162667 discloses an overhead scanner in which a reading operation is performed while a document is pressed by hands at positions determined as opposing corners in a desired read area in the document, the boundary between the document and the hands pressing the document is detected, and an area is masked that is outside a rectangle in which the innermost two pairs of coordinates of the right and left hands form a diagonal line.

JP-A-H10-327312 discloses an overhead scanner that receives a coordinate position indicated with a coordinate input pen by an operator, recognizes an area connecting input coordinates as an area to be cropped, and selectively irradiates the area to be cropped with light.

JP-A-2005-167934 discloses a document reading apparatus, as a flat-bed type scanner, that recognizes an area to be read and a size of a document from an image pre-scanned by an area sensor and reads the document by a linear sensor.

However, the conventional scanner devices have some problem that when part of an area is desired to be cropped from a read image, the operation is complicated because the devices require an operation to previously specify an area to be cropped on a console before scanning or require an operation to specify an area to be cropped on an image editor after scanning.

For example, the overhead scanner described in JP-A-H06-105091 has a problem that because only a document area in a sub-scanning direction (lateral direction) is specified although the skin color of the hand is detected to correct an image of the hand included therein, this scanner cannot be applied to a case where part of an area to be cropped is desired to be specified from a read image.

The overhead scanner described in JP-A-H07-162667 has a problem that, because skin color is detected and the innermost pairs of coordinates of the edge of the right and left hands are used as points determined as opposing corners of a rectangle to be cropped, points of coordinates that are not those of fingertips that are not intended by the user may be erroneously detected.

The overhead scanner described in JP-A-H10-327312 has a problem in its operability because a dedicated coordinate input pen has to be used although an image area to be cropped can be specified by the coordinate indicator pen.

The flat-bed type of scanner described in JP-A-2005-167934 has a problem that the operation remains still complicated because although a document size and an offset or the like can be recognized by being pre-scanned by the area sensor, a read image has to be specified using a point pen or the like on editing software in order to specify an area to be cropped.

### SUMMARY OF THE INVENTION

It is an object of the present invention to at least partially solve the problems in the conventional technology.

An overhead scanner device according to one aspect of the present invention includes an image photographing unit, and a control unit, wherein the control unit includes an image acquiring unit that controls the image photographing unit to acquire an image of a document including at least an indicator provided by a user, a specific-point detecting unit that detects two specific points each determined based on the distance from the gravity center of an indicator to the end of the indicator, from the image acquired by the image acquiring unit, and an image cropping unit that crops the image acquired by the image acquiring unit into a rectangle with opposing corners at the two points detected by the specific-point detecting unit.

An image processing method according to another aspect of the present invention is executed by an overhead scanner device including an image photographing unit, and a control unit. The method executed by the control unit includes an image acquiring step of controlling the image photographing unit to acquire an image of a document including at least an indicator provided by a user, a specific-point detecting step of detecting two specific points each determined based on the distance from the gravity center of an indicator to the end of the indicator, from the image acquired at the image acquiring step, and an image cropping step of cropping the image acquired at the image acquiring step into a rectangle with opposing corners at the two points detected at the specific-point detecting step.

A computer-readable recording medium according to still another aspect of the present invention stores therein a computer program for an overhead scanner device including an image photographing unit, and a control unit. The computer program causes the control unit to execute an image acquiring step of controlling the image photographing unit to acquire an image of a document including at least an indicator provided by a user, a specific-point detecting step of detecting two specific points each determined based on the distance from the gravity center of an indicator to the end of the indicator, from the image acquired at the image acquiring step, and an image cropping step of cropping the image acquired at the image acquiring step into a rectangle with opposing corners at the two points detected at the specific-point detecting step.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram of an example of a configuration of the overhead scanner device 100;

FIG. 2 is a view depicting one example of an external appearance of the image photographing unit 110 where the document is placed, and also depicting a relationship among the main scanning direction, the sub-scanning direction, and the rotation direction of the image sensor 13 by the motor 12;

FIG. 3 is a flowchart of an example of main processing of the overhead scanner device 100 according to the present embodiment;

FIG. 4 is a view illustrating one example of two specific points detected on the image and an area to be cropped based on the two specific points;

FIG. 5 is a view schematically illustrating a method for detecting a specific point based on the distance from the gravity center of an indicator to the end of the indicator on an image in a process performed by the specific-point detecting unit 102b;

FIG. 6 is a view schematically illustrating a method for detecting a specific point based on the distance from the gravity center of an indicator to the end of the indicator on an image in a process performed by the specific-point detecting unit 102b;

FIG. 7 is a flowchart representing one example of the embodying processing in the overhead scanner device 100 according to the present embodiment;

FIG. 8 is a view schematically illustrating one example of a method for detecting a fingertip by the specific-point detecting unit 102b;

FIG. 9 is a view schematically representing a method for determining fingertip relevance using the normal vectors, the image, and weighting factors;

FIG. 10 is a view illustrating gravity centers of the left and right hands, specific points of the fingertips, and an area to be cropped, which are detected on the image data;

FIG. 11 is a view schematically illustrating the area eliminating process;

FIG. 12 is a view illustrating an example in which an area to be eliminated is specified by sticky notes;

FIG. 13 is a view illustrating an example in which an area to be eliminated is specified by sticky notes;

FIG. 14 is a flowchart representing an example of a single-handed operation of the overhead scanner device 100 according to the present embodiment;

FIG. 15 is a view illustrating a case in which a first specific point and a second specific point are detected; and

FIG. 16 is a view illustrating a case in which a third specific point and a fourth specific point are detected.

### DETAILED DESCRIPTION OF THE PREFERRED EMBODIMENTS

Embodiments of an overhead scanner device, an image processing method, and a computer-readable recording medium according to the present invention will be explained in detail below based on the drawings. The embodiments do not limit the invention.

### 1. Configuration of the Embodiment

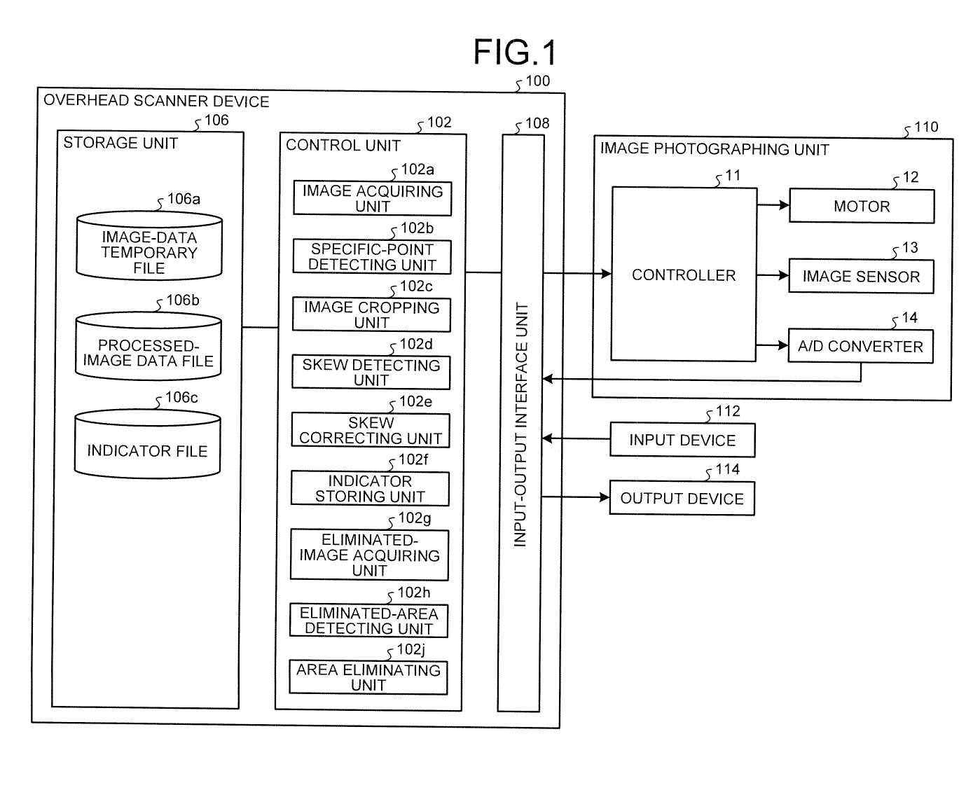

The configuration of an overhead scanner device 100 according to the present embodiment is explained below with reference to FIG. 1. FIG. 1 is a block diagram of an example of a configuration of the overhead scanner device 100.

As shown in FIG. 1, the overhead scanner device 100 includes at least an image photographing unit 110 that scans a document placed face-up from above, and a control unit 102. In this embodiment, the overhead scanner device 100 further includes a storage unit 106, and an input-output interface unit 108. Each unit of the overhead scanner device 100 is communicably connected to one another via any communication channels.

The storage unit 106 stores the various databases, files and tables. The storage unit 106 is storage means, for example, a memory device such as RAM or ROM, a fixed disk device such as a hard disk, a flexible disk, and an optical disk. The storage unit 106 stores therein computer program for executing various processes when the program is executed by CPU (Central Processing Unit). As shown in FIG. 1, the storage unit 106 includes an image-data temporary file 106a, a processed-image data file 106b, and an indicator file 106c.

Among these, the image-data temporary file 106a temporarily stores therein image data read by the image photographing unit 110.

The processed-image data file 106b stores therein image data processed by the control unit 102 such as an image cropping unit 102c and a skew correcting unit 102e, which will be explained later, from the image data read by the image photographing unit 110.

The input-output interface unit 108 has a function for connecting to the overhead scanner device 100 with the image photographing unit 110, an input device 112 or an output device 114. A monitor (including a television for home use), a speaker, a printer or the like may be used as the output device 114 (the output device 114 is sometimes described as the monitor 114 in below). A keyboard, a mouse device, a microphone, or a monitor that realizes a pointing device function in cooperation with the mouse device may be used as the input device 112. A foot switch that can be operated by foot may be used as the input device 112.

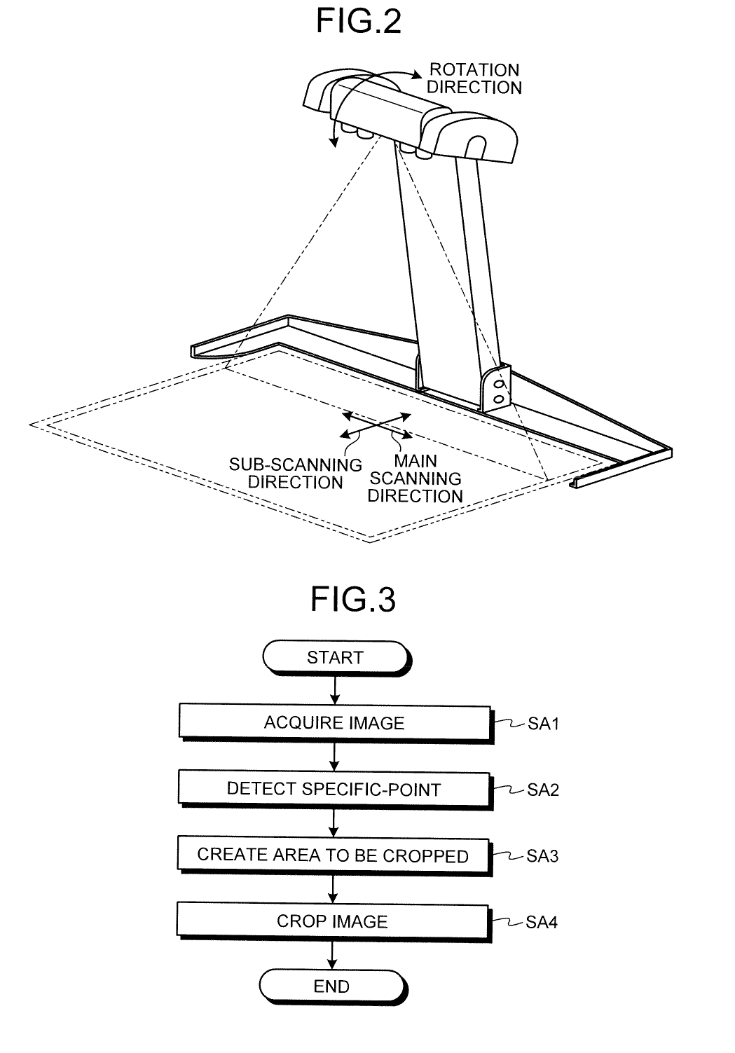

The image photographing unit 110 scans a document placed face-up from above to read an image of the document. In the present embodiment, as shown in FIG. 1, the image photographing unit 110 includes a controller 11, a motor 12, an image sensor 13 (e.g., area sensor and line sensor), and an analog-to-digital (A/D) converter 14. The controller 11 controls the motor 12, the image sensor 13, and the A/D converter 14 according to an instruction from the control unit 102 via the input-output interface unit 108. When a one-dimensional line sensor is used as the image sensor 13, the image sensor 13 photoelectrically converts the light reaching from a line in the main scanning direction of the document thereto into an analog quantity of electric charge for each pixel on the line. The A/D converter 14 converts the analog quantity of electric charge amount output from the image sensor 13 into a digital signal, and outputs one-dimensional image data. The motor 12 is driven to rotate, and a document line as an object to be read by the image sensor 13 thereby shifts to the sub-scanning direction. In this way, the one-dimensional image data is output from the A/D converter 14 for each line, and the control unit 102 combines these image data to generate two-dimensional image data. FIG. 2 illustrates one example of an external appearance of the image photographing unit 110 where the document is placed and also illustrates a relationship among the main scanning direction, the sub-scanning direction, and the rotation direction of the image sensor 13 by the motor 12.

As shown in FIG. 2, when the document is placed face-up and is photographed by the image photographing unit 110 from above, the one-dimensional image data for the illustrated line in the main scanning direction is read by the image sensor 13. Together with rotation of the image sensor 13 driven by the motor 12 in the illustrated rotation direction, the line read by the image sensor 13 shifts to the illustrated sub-scanning direction. This allows the two-dimensional image data for the document to be read by the image photographing unit 110.

Referring back again to FIG. 1, the indicator file 106c is an indicator storage unit that stores therein a color, a shape, and the like, of an indicator provided by a user. Here, the indicator file 106c may store therein color (skin color) of a user's hand or finger or may store therein a shape of a projecting end such as a fingertip of the user's hand indicating a point to be specified, for each user. Alternatively, the indicator file 106c may store therein color or shape of a sticky note or a pen. Alternatively, the indicator file 106c may store therein characteristics (color or shape) of an indicator, such as a sticky note or a pen, for specifying an area to be cropped and characteristics (color or shape) of an indicator, such as a sticky note or a pen, for specifying an area to be eliminated from the area to be cropped.

The control unit 102 is a CPU or the like that performs overall control on the overhead scanner device 100. The control unit 102 includes an internal memory for storing a control program, programs that define various processing procedures, and necessary data. The control unit 102 performs information processing for executing various processing by these programs or the like. As shown in FIG. 1, the control unit 102 schematically includes an image acquiring unit 102a, a specific-point detecting unit 102b, an image cropping unit 102c, a skew detecting unit 102d, a skew correcting unit 102e, a indicator storing unit 102f, an eliminated-image acquiring unit 102g, an eliminated-area detecting unit 102h, and an area eliminating unit 102j.

The image acquiring unit 102a controls the image photographing unit 110 to acquire an image of the document including at least an indicator provided by the user. For example, the image acquiring unit 102a controls the controller 11 of the image photographing unit 110 to rotate the motor 12, combines one-dimensional image data for each line being photoelectrically converted by the image sensor 13 and subjected to analog-to-digital conversion by the A/D converter 14, to generate two-dimensional image data, and stores the generated image data in the image-data temporary file 106a. Alternatively, the image acquiring unit 102a may control the image photographing unit 110 to sequentially acquire two-dimensional images at predetermined time intervals from the image sensor 13 that is an area sensor. Here, the image acquiring unit 102a may control the image photographing unit 110 to, in response to a predetermined acquisition trigger (e.g., a stop of a finger, a sound input/output, or a push of a foot switch), chronologically acquire two images of a document including an indicator that is provided by a user. For example, if the indicator is a fingertip and when the user speaks while indicating a specific point on the document with one of his/her hands, the image acquiring unit 102a acquires an image in response to a trigger that is a sound input from the input device 112 that is a microphone. If an area sensor and a line sensor are used as the image sensor 13 and when the user stops his/her hand to indicate a specific point on the document, the image acquiring unit 102a may acquire, based on a group of images that are sequentially acquired by the area sensor, an image with high precision acquired by using the line sensor in response to a trigger that is a stop of the user's finger.

The specific-point detecting unit 102b detects two specific points each determined based on the distance from the gravity center of an indicator to the end of the indicator from an image acquired by the image acquiring unit 102a. Specifically, the specific-point detecting unit 102b detects specific points each based on image data that is stored by the image acquiring unit 102a in the image-data temporary file 106a and based on the distance from the gravity center of an indicator to the end of the indicator. More specifically, the specific-point detecting unit 102b may detect as a specific point on the side of the end (end point) of a vector whose vector length from the gravity center of the indicator to the end of the indicator is equal to or more than a predetermined length. The specific-point detecting unit 102b does not have to detect two specific points from an image including two indicators. Alternatively, the specific-point detecting unit 102b may detect two specific points by detecting a specific point from each of two images each including an indicator. Here, the indicator is one having a projecting end indicating a point to be specified, and is, as one example, an object such as a fingertip of a user's hand, a sticky note, and a pen provided by the user. For example, the specific-point detecting unit 102b detects a skin-color portion area from the image based on the image data acquired by the image acquiring unit 102a, and detects an indicator such as the fingertip of the hand. The specific-point detecting unit 102b may detect the indicator on an image using a known pattern recognition algorism or the like from the image based on the image data acquired by the image acquiring unit 102a, based on any one or both of the color and the shape stored in the indicator file 106c by the indicator storing unit 102f. The specific-point detecting unit 102b may also detect two points specified by fingertips of the left and right hands being indicators from the image based on the image data acquired by the image acquiring unit 102a. In this case, the specific-point detecting unit 102b creates a plurality of finger-direction vectors directed from the gravity center of the hand being the indicator detected as the skin-color portion area toward its periphery. Of the created finger-direction vectors, the specific-point detecting unit 102b may detect a specific point by recognizing as the fingertip the end of the finger-direction vector whose normal vector is overlapped with the portion area in width closest to a predetermined value. In addition, the specific-point detecting unit 102b may detect two points specified by two sticky notes being the indicators, from the image based on the image data acquired by the image acquiring unit 102a. The specific-point detecting unit 102b may also detect two points specified by two pens being the indicators, from the image based on the image data acquired by the image acquiring unit 102a.

The image cropping unit 102c crops an image acquired by the image acquiring unit 102a into a rectangle with opposing corners at the two points detected by the specific-point detecting unit 102b. More specifically, the image cropping unit 102c determines, as an area to be cropped, a rectangle with two points being opposing corners detected by the specific-point detecting unit 102b, acquires image data corresponding to the area to be cropped from the image data stored in the image-data temporary file 106a by the image acquiring unit 102a, and stores the cropped or processed image data in the processed-image data file 106b. Here, the image cropping unit 102c may determine, as an area to be cropped, the rectangle structured with detected two points being opposing corners and with lines parallel to document edges according to the skew of the document detected by the skew detecting unit 102d. In other words, when the document is skewed, the characters and graphics described in the document may also be skewed. Therefore, the image cropping unit 102c may determine a rectangle which is skewed according to the skew of the document detected by the skew detecting unit 102d, as an area to be clopped.

The skew detecting unit 102d detects a skew of the document from the image acquired by the image acquiring unit 102a. More specifically, the skew detecting unit 102d detects document edges or the like to detect a skew of the document based on the image data stored in the image-data temporary file 106a by the image acquiring unit 102a.

The skew correcting unit 102e corrects the skew of the image cropped by the image cropping unit 102c using the skew detected by the skew detecting unit 102d. More specifically, the skew correcting unit 102e rotates the image cropped by the image cropping unit 102c according to the skew detected by the skew detecting unit 102d so as to eliminate the skew. For example, when the skew detected by the skew detecting unit 102d is θ°, the skew correcting unit 102e rotates −θ° with respect to the image cropped by the image cropping unit 102c, to thereby generate image data in which the skew is corrected, and stores the generated image data in the processed-image data file 106b.

The indicator storing unit 102f stores any one or both of the color and the shape of the indicator provided by the user in the indicator file 106c. For example, the indicator storing unit 102f learns any one or both of the color and the shape of the indicator using a known learning algorithm, from the image of the indicator without the document acquired by the image acquiring unit 102a, and may store the color and the shape as a result of learning in the indicator file 106c.

An eliminated-image acquiring unit 102g is eliminated-image acquiring means that acquires an image of a document including an indicator that is provided by the user in a rectangle with opposing corners at two specific points detected by the specific-point detecting unit 102b. As is the case with the image acquiring unit 102a, the eliminated-image acquiring unit 102g may control the image photographing unit 110 to acquire an image of a document. Specifically, the eliminated-image acquiring unit 102g may control the image photographing unit 110 to acquire an image in response to a predetermined acquisition trigger (e.g., a stop of a finger, a sound input/output, or a push of a foot switch).

An eliminated-area detecting unit 102h is eliminated-area detecting means that detects an area specified by the indicator from the image that is acquired by the eliminated-image acquiring unit 102g. For example, the eliminated-area detecting unit 102h may detect, as “the area specified by the indicator”, an area (rectangle with opposing corners at two points, etc.) specified by the user with the indicator. The eliminated-area detecting unit 102h may determine, in a rectangle with opposing corners at two specific points, a point specified by the user at which two lines dividing the rectangle into four areas intersect and then detect one of the four areas as “an area specified by an indicator” by using a point specified by the user. The eliminated-area detecting unit 102h may detect the point specified by the indicator as is the same with the process performed by the specific point detecting unit 102b to detect a specific point.

An area eliminating unit 102j is area eliminating means that eliminates the area that is detected by the eliminated-area detecting unit 102h from the image cropped by the image cropping unit 102c. For example, the area eliminating unit 102j may eliminate the area from the area to be cropped before cropping by the image cropping unit 102c. Alternatively, the area may be eliminated from the cropped image after cropping by the image cropping unit 102c.

### 2. Processing of the Embodiment

Examples of processing executed by the overhead scanner device 100 having the above configuration are explained below with reference to FIGS. 3 to 16.

2-1. Main Processing

An example of main processing executed by the overhead scanner device 100 according to the present embodiment is explained below with reference to FIGS. 3 to 6. FIG. 3 is a flowchart of an example of main processing of the overhead scanner device 100 according to the present embodiment.

As shown in FIG. 3, first, the image acquiring unit 102a controls the image photographing unit 110 to acquire an image of a document including at least an indicator provided by the user, and stores image data for the image in the image-data temporary file 106a (Step SA1). The image acquiring unit 102a may control the image photographing unit 110 to acquire two images of a document each including an indicator provided by a user in response to a predetermined acquisition trigger (e.g., a stop of a finger, a sound input/output, or a push of a foot switch). Here, the indicator may represent one having a projecting end indicating a point to be specified, and may be, as one example, an object such as a fingertip of the hand, a sticky note, and a pen provided by the user.

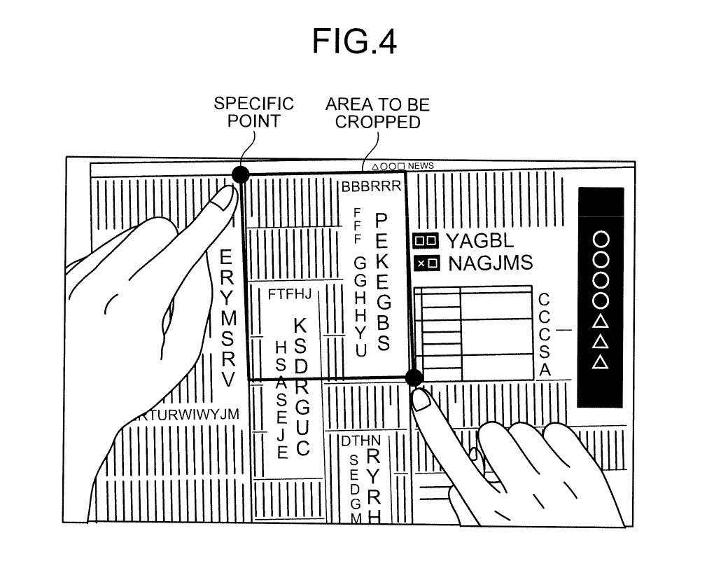

The specific-point detecting unit 102b detects two specific points each determined based on the distance from the gravity center of an indicator to the end of the indicator, based on the image data stored in the image-data temporary file 106a by the image acquiring unit 102a (Step SA2). More specifically, the specific-point detecting unit 102b may detect a specific point on the side of the end (end point) by using a vector whose vector length from the gravity center of an indicator to the end of the indicator is equal to or more than a predetermined length. The specific-point detecting unit 102b does not have to detect two specific points from an image including two indicators. Alternatively, the specific-point detecting unit 102b may detect two specific points by detecting a specific point from each of two images each including an indicator. For example, the specific-point detecting unit 102b may identify areas of the indicators on the image using the color and shape, from the image based on the image data, and may detect two specific points specified by the identified indicators. FIG. 4 is a view illustrating one example of two specific points detected on the image and an area to be cropped based on the two specific points.

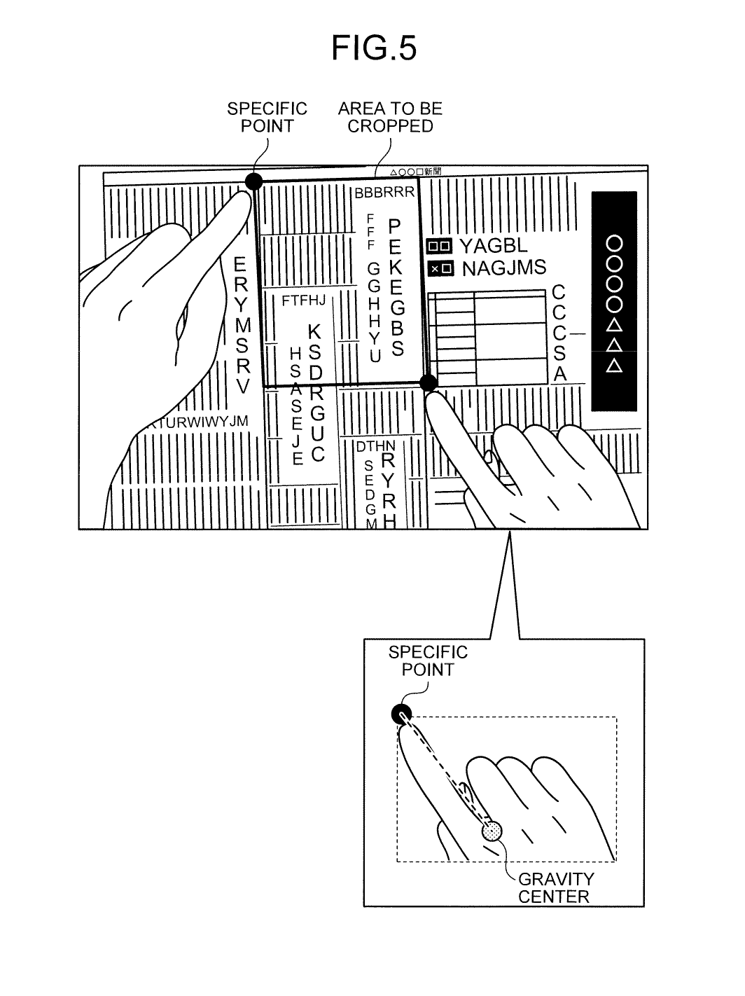

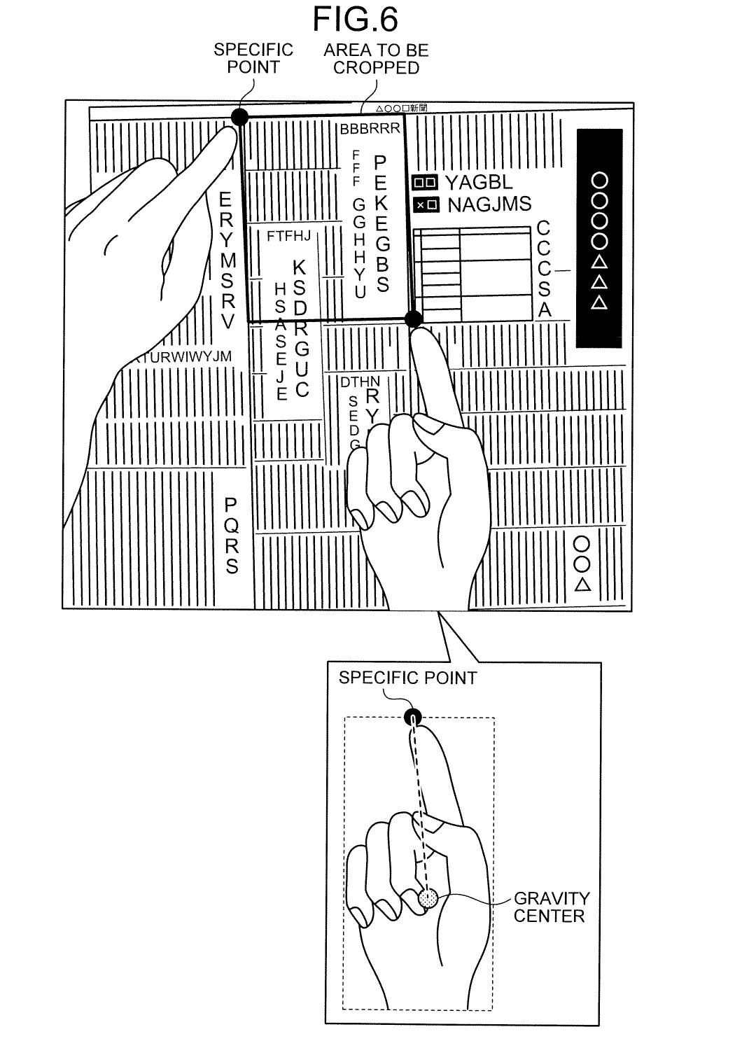

As illustrated in FIG. 4, when the user uses his/her fingers as the indicators to specify two points as opposing corners of an area, which the user desires to crop, on a document such as a newspaper, the specific-point detecting unit 102b may detect a skin-color portion area from the image based on the image data to detect fingertips of the hands being the indicators, and detect two specific points specified by the respective fingertips. FIGS. 5 and 6 are views schematically illustrating a method for detecting a specific point based on the distance from the gravity center of an indicator to the end of the indicator on an image in a process performed by the specific-point detecting unit 102b.

As illustrated in FIG. 5, the specific-point detecting unit 102b may detect an indicator on an image based on characteristics of the indicator stored in the indicator file 106c and then detect a specific point on the side of the end (end point) of a vector whose vector length from the gravity center of the detected indicator to the end of the indicator is equal to or more than a predetermined length. In other words, the line segment from the gravity center toward the end is used as a vector in the direction of a fingertip and a specific point is detected based on the distance. Accordingly, the direction indicated by the finger and the fingertip are recognized as vectors and thus, regardless of the angle of the fingertip, a specific point can be detected as the user intends. Because a specific point is detected based on the distance from the gravity center to the end, the specific point does not have to be on the inner side of each indicator as illustrated in FIGS. 4 and 5. In other words, as illustrated in FIG. 6, even if the point intended by the user is not in the leftmost end in the area of the hand and the fingertip faces straight up, the specific-point detecting unit 102b can accurately detect a specific point based on the distance from the gravity center to the end (for example, by determining whether the distance is equal to or more than a predetermined length). Because the overhead scanner device 100 is positioned opposite the user and a document is positioned between the overhead scanner device 100 and the user, the angle by which the user points the document is limited due to their positional relationship. The specific-point detecting unit 102b may utilize this limitation to recognize detection using a vector in a predetermined direction (for example, unnatural downward direction) as an error and thus detect no specific point, thereby improving detection precision. FIGS. 4 to 6 illustrate an example in which two specific points are specified simultaneously by using both of hands. Alternatively, when the image acquiring unit 102a acquires two images of a document each including an indicator, the specific-point detecting unit 102b may detect two specific points each specified by each of the indicators in the acquired two images. Furthermore, detection of a specific point by using an indicator is described above. Alternatively, two or more specific points may be detected by using an indicator. For example, when an indicator is a fingertip of a hand, the user may use two fingers, such as a thumb and a forefinger to simultaneously specify two specific points determined as opposing corners of an area to be cropped. The specific-point detecting unit 102b may recognize that a predetermined number (for example, three) of vectors or more are contained in an indicator is unnatural and excludes an indicator from which the predetermined number of vectors or more are detected, thereby increasing detection accuracy.

The indicator is not limited to a fingertip of a hand. The specific-point detecting unit 102b may also detect two specific points specified by two sticky notes being the indicators, from the image based on the image data. In addition, the specific-point detecting unit 102b may detect two specific points specified by two pens being the indicators, from the image based on the image data.

Referring back again to FIG. 3, the image cropping unit 102c creates an area to be cropped as a rectangle with opposing corners at the two specific points detected by the specific-point detecting unit 102b (Step SA3). As illustrated in FIG. 4 as one example, the rectangle with opposing corners at the two specific points may be a quadrilateral such as oblong and square formed with lines parallel to a read area by the image photographing unit 110 or to document edges.

The image cropping unit 102c extracts image data corresponding to an area to be cropped, from the image data stored in the image-data temporary file 106a by the image acquiring unit 102a, and stores the extracted image data in the processed-image data file 106b (Step SA4). The image cropping unit 102c may output the cropped image data to the output device 114 such as a monitor.

That is one example of the main processing in overhead scanner device 100 according to the present embodiment.

2-2. Embodying Processing

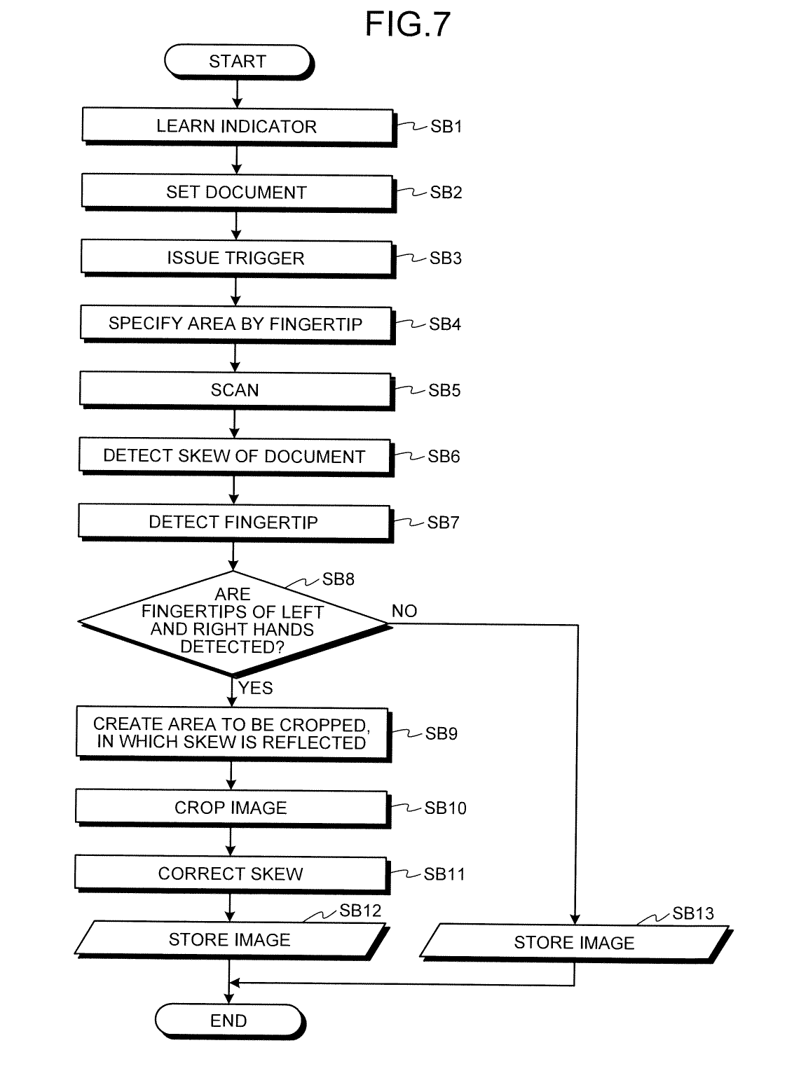

Subsequently, one example of an embodying processing further including an indicator learning process and a skew correction process in the main processing will be explained below with reference to FIG. 7 to FIG. 11. FIG. 7 is a flowchart representing one example of the embodying processing in the overhead scanner device 100 according to the present embodiment.

As shown in FIG. 7, first, the indicator storing unit 102f learns any one or both of color and shape of the indicator provided by the user (Step SB1). For example, the indicator storing unit 102f learns any one or both of the color and the shape of the indicator using a known learning algorism from the image of the indicator not including the document acquired by the image acquiring unit 102a, and stores the color and the shape as a result of the learning in the indicator file 106c. As one example, at previous steps (before Steps SB2 to SB5 explained later), the image acquiring unit 102a may cause the image photographing unit 110 to scan only the indicator (not including the document) to acquire the scanned image, and the indicator storing unit 102f may store attributes (color and shape, etc.) of the indicator in the indicator file 106c based on the image acquired by the image acquiring unit 102a. For example, when the indicator is a finger or a sticky note, the indicator storing unit 102f may read the color (skin color) of the finger or the color of the sticky note from the image including the indicator and store the read color in the indicator file 106c. It is not limited to reading the color of the indicator based on the image acquired by the image acquiring unit 102a, but the indicator storing unit 102f may cause the user to specify the color through the input device 112. When the indicator is a pen, the indicator storing unit 102f may extract the shape of the pen from the image acquired by the image acquiring unit 102a and store the extracted shape in the indicator file 106c. The shape or the like stored in the indicator file 106c is used for the specific-point detecting unit 102b to search for the indicator (to perform pattern matching on the indicator).

When the user sets the document on a read area of the image photographing unit 110 (Step SB2), the image acquiring unit 102a issues a read-start trigger performed by the image photographing unit 110 (Step SB3). For example, the image acquiring unit 102a may use an interval timer due to internal clock of the control unit 102 to start reading after passage of a predetermined time. In this manner, in the embodying processing, because the user specifies the area to be cropped using his/her both hands, the image acquiring unit 102a does not cause the image photographing unit 110 to start reading immediately after an input for starting reading is provided by the user through the input device 112 but issues the trigger using the interval timer or the like. In addition, the read-start trigger may be issued in response to a predetermined acquisition trigger, such as a stop of a finger, a sound input/output, or a push of a foot switch.

When the user specifies the area to be cropped by the fingertips of both hands (Step SB4), the image acquiring unit 102a controls the image photographing unit 110 to scan the image of the document including the fingertips of both hands provided by the user at a timing according to the issued trigger, and stores the image data in the image-data temporary file 106a (Step SB5).

The skew detecting unit 102d detects the document edges from the image based on the image data stored in the image-data temporary file 106a by the image acquiring unit 102a, to detect the skew of the document (Step SB6).

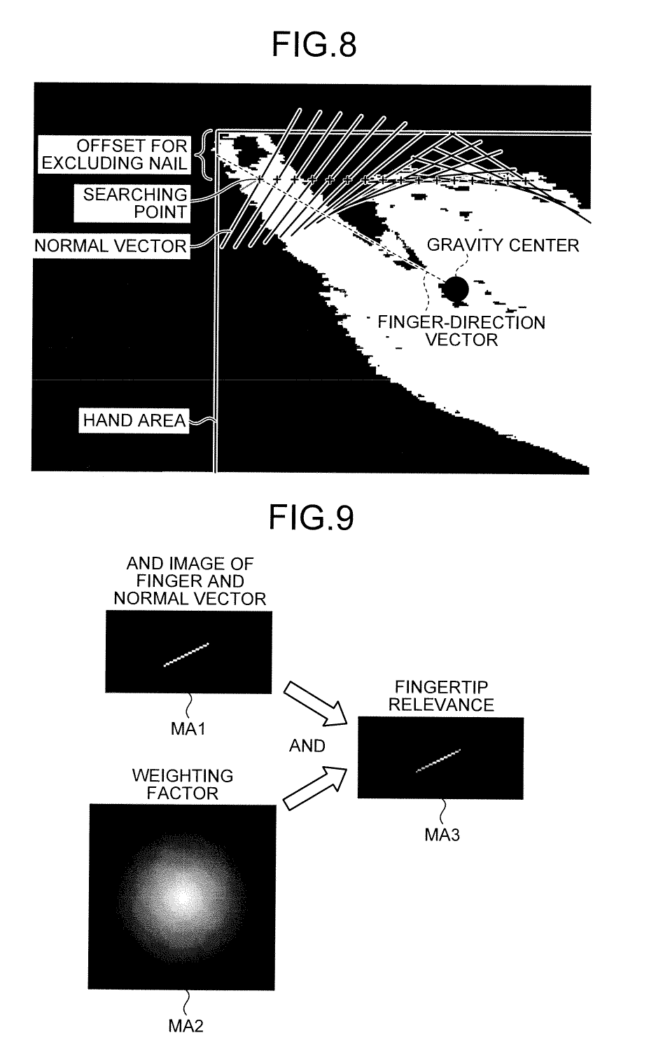

The specific-point detecting unit 102b detects an indicator such as fingertips of the hands using the known pattern recognition algorism or the like from the image based on the image data stored in the image-data temporary file 106a by the image acquiring unit 102a, based on the color (skin color) and the shape as a result of learning stored in the indicator file 106c by the indicator storing unit 102f. The specific-point detecting unit 102b then detects two points specified by the fingertips of both hands (Step SB7). More specifically, the specific-point detecting unit 102b creates a plurality of finger-direction vectors directed from the gravity center of the hand being the indicator detected as the skin-color portion area toward its periphery. Of the created finger-direction vectors, the specific-point detecting unit 102b may detect a specific point by recognizing as the fingertip the end of the finger-direction vector whose normal vector is overlapped with the portion area in width closest to a predetermined value. This example will be explained in detail below with reference to FIG. 8 to FIG. 10. FIG. 8 is a view schematically illustrating one example of a method for detecting a fingertip by the specific-point detecting unit 102b.

As illustrated in FIG. 8, the specific-point detecting unit 102b extracts only a color hue of the skin color using color space conversion, from color image data stored in the image-data temporary file 106a by the image acquiring unit 102a. In FIG. 8, a white area represents a skin-color portion area of a color image, and a black area represents an area other than the skin color of the color image.

The specific-point detecting unit 102b determines the gravity center of the extracted skin-color portion area, and determines respective areas of the left and right hands. In FIG. 8, the area indicated as “hand area” represents a right-hand portion area.

The specific-point detecting unit 102b sets searching points in a line apart from the above of the determined hand area a predetermined distance (offset amount). More specifically, because there may be a nail whose color is not the skin color in a predetermined area from the fingertip toward the gravity center of the hand, the specific-point detecting unit 102b provides the offset to detect the fingertip in order to avoid reduction in detection precision due to the nail.

The specific-point detecting unit 102b determines finger-direction vectors directed from the gravity center to the searching points. More specifically, because the finger extends from the gravity center of the hand and protrudes toward the periphery of the hand, the specific-point detecting unit 102b first determines the finger-direction vectors in order to search for the finger. The broken line in FIG. 8 represents a finger-direction vector passing through leftmost one of the searching points. As such, the specific point detecting unit 102b determines a finger-direction vector at each of the searching points.

The specific-point detecting unit 102b then determines each normal vector for the finger-direction vectors. In FIG. 8, each of line segments passing through respective searching points represents a normal vector at each of the searching points. FIG. 9 is a view schematically representing a method for determining fingertip relevance using the normal vectors, the image, and weighting factors.

The specific-point detecting unit 102b overlaps the normal vectors and a skin-color binary image (e.g., an image of the skin-color portion area illustrated as white in FIG. 8) to calculate an AND image. As shown in MA1 on the upper left side in FIG. 9, the AND image represents an area (overlapping width) on which the line segments of the normal vectors and the skin-color portion area overlap, which expresses a thickness of the finger.

The specific-point detecting unit 102b multiplies the AND image by each weighting factor, to calculate the fingertip relevance. MA2 on the lower left side in FIG. 9 is a view schematically representing the weighting factor. As shown in MA2, the weighting factor is a factor that becomes greater as being closer to the center, and thus it is set so that the relevance becomes high when the center of the fingertip is captured. MA3 on the right side in FIG. 9 is an AND image between the AND image and the image of the weighting factor, and it is set so that the relevance becomes higher as the weighting factor is closer to the center of the segment line. In this manner, the use of the weighting factor allows calculation in such a manner that a candidate catching a position closer to the center of the fingertip has higher relevance.

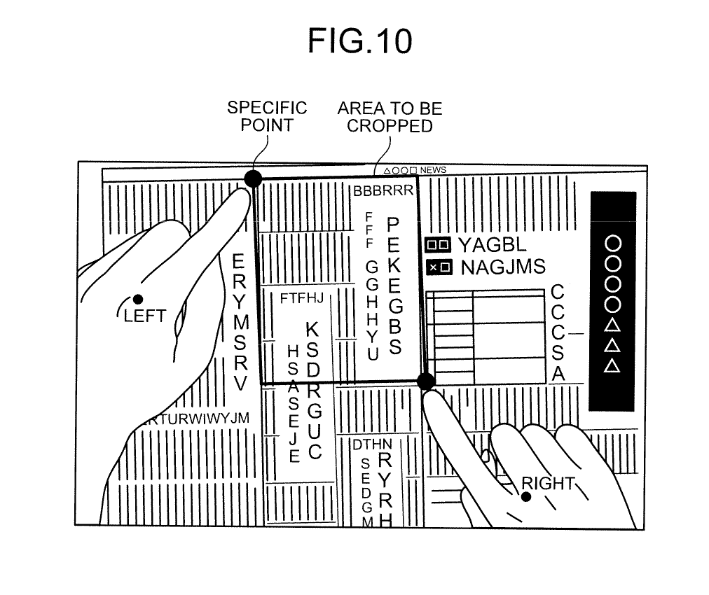

The specific-point detecting unit 102b then determines relevance of each of the normal vectors at the searching points, finds out a position where the fingertip relevance is the highest, and determines the position as a specific point. FIG. 10 is a view illustrating gravity centers of the left and right hands (two points described as “LEFT” and “RIGHT” in this figure), specific points of the fingertips (two black solid circles specified by the fingertips in this figure), and an area to be cropped (rectangle in this figure) detected on the image data.

As explained above, the specific-point detecting unit 102b determines the two specific points specified by the fingertips from the gravity centers of the left and right hands.

Referring back again to FIG. 7, when the two specific points specified by the fingertips of the left and right hands are detected by the specific-point detecting unit 102b (Yes at Step SB8), the image cropping unit 102c creates a rectangle, as an area to be cropped, in which the detected two specific points are determined as opposing corners and to which a skew detected by the skew detecting unit 102d is reflected (Step SB9). For example, when the skew detected by the skew detecting unit 102d is θ°, the image cropping unit 102c determines a rectangle skewed θ°, as an area to be cropped, in which the detected two specific points are determined as opposing corners.

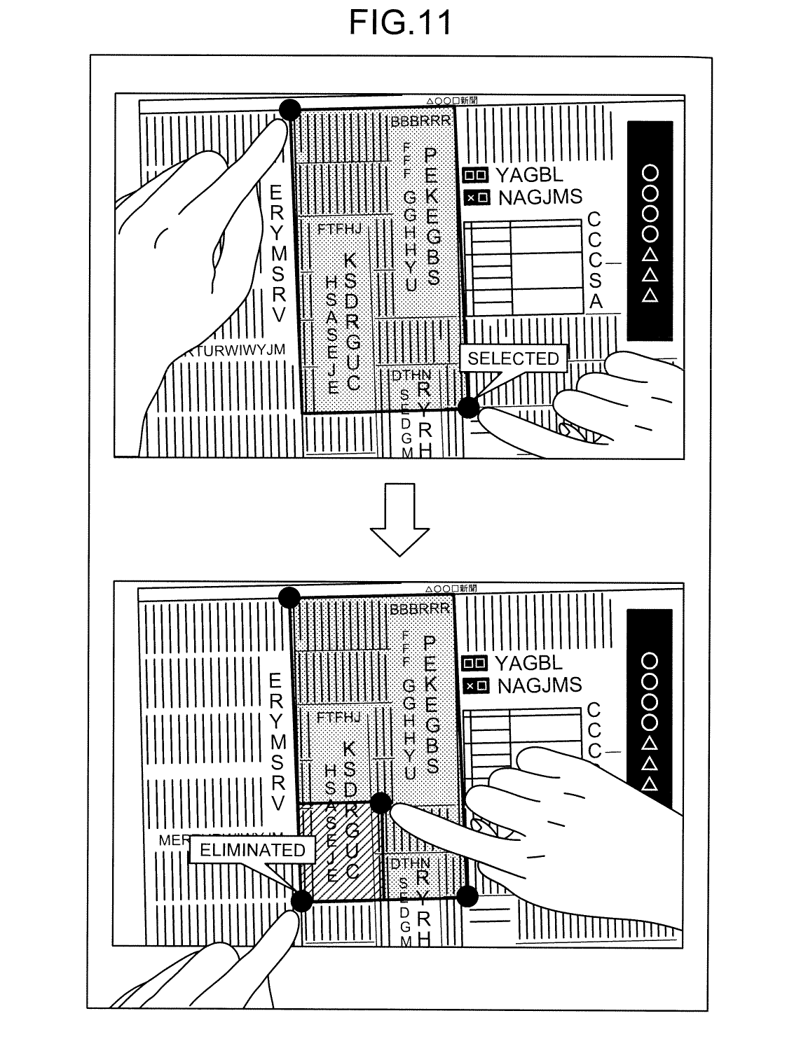

The image cropping unit 102c then crops the image as the created area to be cropped from the image data stored in the image-data temporary file 106a by the image acquiring unit 102a (Step SB10). The control unit 102 of the overhead scanner device 100 may perform an area eliminating process for eliminating an area from an area to be cropped. FIG. 11 is a view schematically illustrating the area eliminating process.

After the specific-point detecting unit 102b detects two specific points of fingertips of right and left hands as illustrated in the upper view in FIG. 11, the eliminated-image acquiring unit 102g acquires an image of a document including indicators provided by a user in a rectangle with opposing corners at the two specific points detected by the specific-point detecting unit 102b as illustrated in the lower view in FIG. 11. The eliminated-area detecting unit 102h detects an area specified by the indicators (the rectangular shaded area in FIG. 11 with opposing corners at two points) from the image acquired by the eliminated-image acquiring unit 102g. Finally, the area eliminating unit 102j eliminates the area detected by the eliminated-area detecting unit 102h from the image cropped by the image cropping unit 102c. The area eliminating process may be performed before cropping by the image cropping unit 102c or after cropping by the image cropping unit 102c. When the same indicators are used, it is necessary for the user to determine whether an area to be cropped is specified or an area to be eliminated from the area to be cropped is specified. As an example, as illustrated in FIG. 11, an area to be cropped and an area to be eliminated from the area to be cropped may be identified by specifying two points on the upper left and the lower right to specify the area to be cropped and by specifying two points on the upper right and lower left to specify the area to be eliminated from the area to be cropped. Alternatively, they can be identified based on the state (color, shape, etc.) of the indicators. For example, an area to be cropped and an area to be eliminated from the area to be cropped may be identified by using a forefinger to specify the area to be cropped and by using a thumb to specify the area to be eliminated from the area to be cropped.

Referring back again to FIG. 7, the skew correcting unit 102e corrects the skew of the image cropped by the image cropping unit 102c using the skew detected by the skew detecting unit 102d (Step SB11). For example, when the skew detected by the skew detecting unit 102d is θ°, the skew correcting unit 102e rotates −θ° with respect to the image cropped by the image cropping unit 102c so as to eliminate the skew, to correct the skew of the image.

The skew correcting unit 102e stores the processed image data in which skew is corrected in the processed-image data file 106b (Step SB12). At Step SB8, when the two specific points specified by the fingertips of the left and right hands are not detected by the specific-point detecting unit 102b (No at Step SB8), the image acquiring unit 102a stores the image data stored in the image-data temporary file 106a in the processed-image data file 106b as it is (Step SB13).

That is one example of the embodying processing in the overhead scanner device 100 according to the present embodiment.

2-2. Example Using Sticky Note

In the above-described embodying processing, an example is described in which specific points are specified by a user using fingertips of his/her both of hands. Alternatively, specific points may be specified by sticky notes or pens. As is the case with fingertips, specific points can be determined based on direction vectors when sticky notes or pens are used. However, because sticky notes and pens do not have uniform color and shape, an algorithm different from that used to detect specific points by fingertips may be used as described below.

First, in a first step, characteristics of indicators are learned. For example, the indicator storing unit 102f previously scans sticky notes or pens that are used as indicators in the processing performed by the image acquiring unit 102a and learns the color and shape of the indicators. The indicator storing unit 102f stores the learned characteristics of the indicators in the indicator file 106c. The indicator storing unit 102f may learn and store the characteristics (color and shape) of an indicator, such as a sticky note or a pen, for specifying an area to be cropped and the characteristics of an indicator, such as a sticky note or a pen, for specifying an area to be eliminated from the area to be cropped such that the area to be cropped and the area to be eliminated can be identified.

In a second step, an image is acquired. For example, when a user positions sticky notes or pens such that specific points specified by the sticky notes or pens are opposite at opposing corners of an area to be cropped from an original, the image acquiring unit 102a controls the image photographing unit 110 to acquire an image of the document including the indicators.

In a third step, the positions of the indicators are searched. For example, the specific-point detecting unit 102b detects the indicators from the acquired image based on the characteristics (color and shape) of the indicators stored in the indicator file 106c. As described above, the positions of sticky notes or pens can be searched based on the learned characteristics.

In a fourth step, specific points are detected. For example, the specific-point detecting unit 102b detects two specific points that are each determined based on the distance from the gravity center of the detected indicator to the end of the indicator. The end point of a sticky note or a pen with respect to the gravity center may appear on both ends. For this reason, the specific-point detecting unit 102b may use, as an indicator to be detected, one of two vectors that is obtained from both ends of one of the indicators and that is directed toward the gravity center of the other indicator and/or is close to the gravity center of the other indicator.

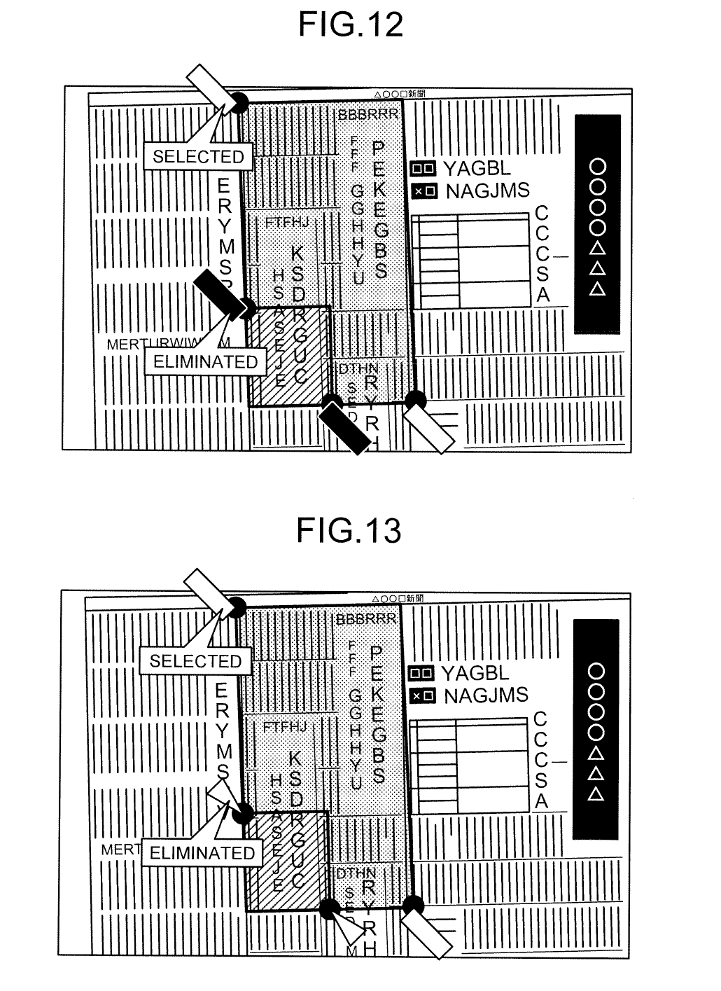

As described above, an area to be cropped can be obtained accurately by determining specific points by using sticky notes or pens. In order to specify an area to be eliminated from the area to be cropped, sticky notes or pens may be used. When the same indicators such as sticky notes or pens are used, because it is necessary to determine whether an area to be cropped is specified or an area to be eliminated from the area to be cropped is specified, the area to be cropped and the area to be eliminated may be identified according to the previously-learned characteristics (color, shape, etc.) of the indicators. FIGS. 12 and 13 are views illustrating an example in which an area to be eliminated is specified by sticky notes.

In this example, indicators that are sticky notes are used as shown in FIG. 12. An area to be cropped and an area to be eliminated from the area to be cropped may be identified by specifying two points using white sticky notes to specify the area to be cropped and by specifying two points using black sticky notes to specify the area to be eliminated. The area to be cropped and the area to be eliminated from the area to be cropped do not have to be identified based on their color difference. Alternatively, they may be identified based on the shape of the indicators. In other words, as illustrated in FIG. 13, the area to be cropped and the area to be eliminated from the area to be cropped may be identified by specifying two points by using rectangular sticky notes to specify the area to be cropped and by specifying two points by using triangular sticky notes to specify the area to be eliminated. The area eliminating process is performed as described above by the indicator storing unit 102f, the eliminated-image acquiring unit 102g, and the eliminated-area detecting unit 102h.

2-4. Single-Handed Operation

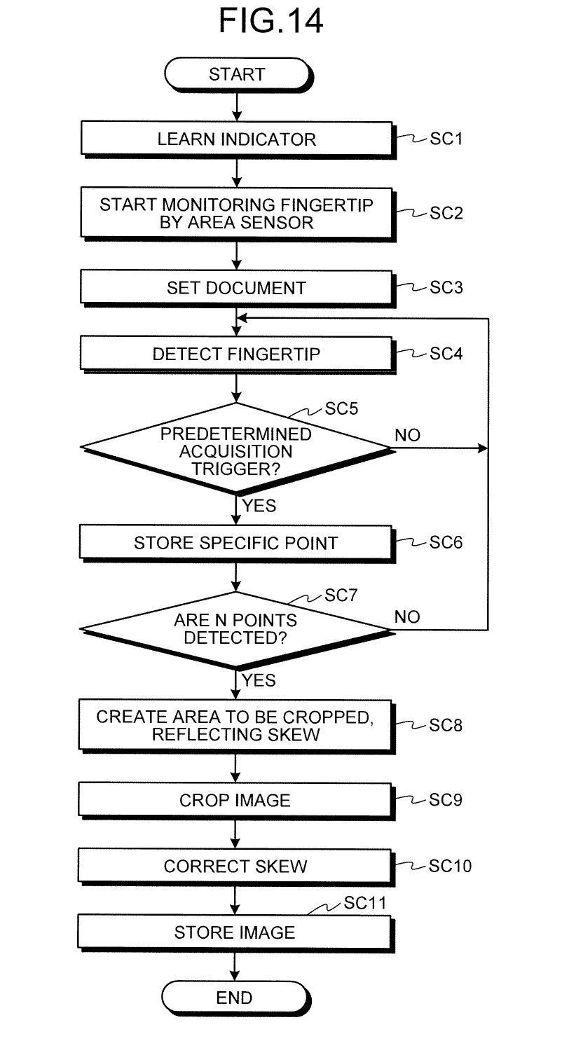

In the above-described examples 2-1 to 2-3, an example is described in which two indicators, such as both of hands or two or more sticky notes, are used simultaneously to specify an area to be cropped and an area to be eliminated. Alternatively, as described below, an area to be cropped and an area to be eliminated may be specified by an indicator. FIG. 14 is a flowchart representing an example of a single-handed operation of the overhead scanner device 100 according to the present embodiment.

As shown in FIG. 14, the indicator storing unit 102f learns the color and/or shape of an indicator that is provided by a user as is the same with Step SB1 (Step SC1).

The image acquiring unit 102a controls the image photographing unit 110 to sequentially acquire two-dimensional images at predetermined intervals from the image sensor 13 that is an area sensor and starts monitoring a fingertip that is the indicator (Step SC2).

When the user places a document in a read area of the image photographing unit 110 (Step SC3), the image acquiring unit 102a detects a fingertip of his/her hand of a user, which is an indicator, from the image acquired by the area sensor (Step SC4).

The image acquiring unit 102a determines whether a predetermined acquisition trigger for acquiring an image occurs. The predetermined acquisition trigger is, for example, a stop of a finger, a sound input/output, or a push of a foot switch. In an example, when the predetermined acquisition trigger is a stop of a finger, the image acquiring unit 102a may determine whether the fingertip stops based on a group of images that are sequentially acquired from the area sensor. When the predetermined trigger is an output of a confirmation sound, the image acquiring unit 102a may determine that a confirmation sound is output from the output device 114, which is a speaker, when a predetermined time has passed after detection of the finger of the hand (Step SC4) based on an internal clock. When the predetermined acquisition trigger is a push of a foot switch, the image acquiring unit 102a may determine whether a push signal is obtained from the input device 112, which is a foot switch.

When the image acquiring unit 102a determines that the predetermined acquisition trigger does not occur (NO at Step SC5), the image acquiring unit 102a returns to the process at Step SC4 to continue monitoring the fingertip.

In contrast, when the image acquiring unit 102a determines that the predetermined acquisition trigger occurs (Yes at Step SC5), the image acquiring unit 102a controls the image photographing unit 110, such as a line sensor, to scan an image of the document including the fingertip of one of the hands provided by the user and stores the image data containing a specific point specified by the fingertip in the image-data temporary file 106a (Step SC6). The process is not limited storing of image data. The specific-point detecting unit 102b or the eliminated-area detecting unit 102h may store only the specific point specified by the detected indicator (for example, the specific point on the side of the end of a vector directed from the gravity center).

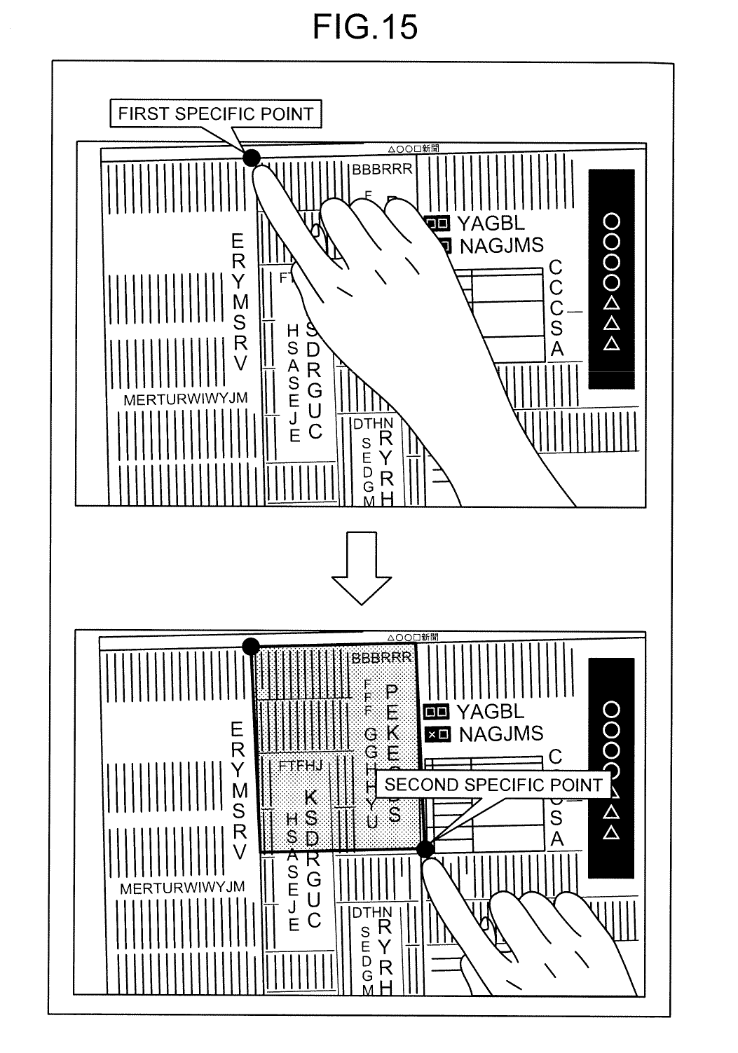

The image acquiring unit 102a determines whether a predetermined number of points, i.e., N points, are detected (Step SC7). For example, N=2 may be satisfied when a rectangular area to be cropped is specified and N=4 may be satisfied when an area to be eliminated from the area to be cropped is specified. When there are x areas to be eliminated, N=2x+2 may be satisfied. When the image acquiring unit 102a determines that the predetermined number of points, i.e., N points, are not detected (No at Step SC7), the image acquiring unit 102a returns to the process at Step SC4 and repeats the above-described process. FIG. 15 is a view illustrating a case in which a first specific point and a second specific point are detected.

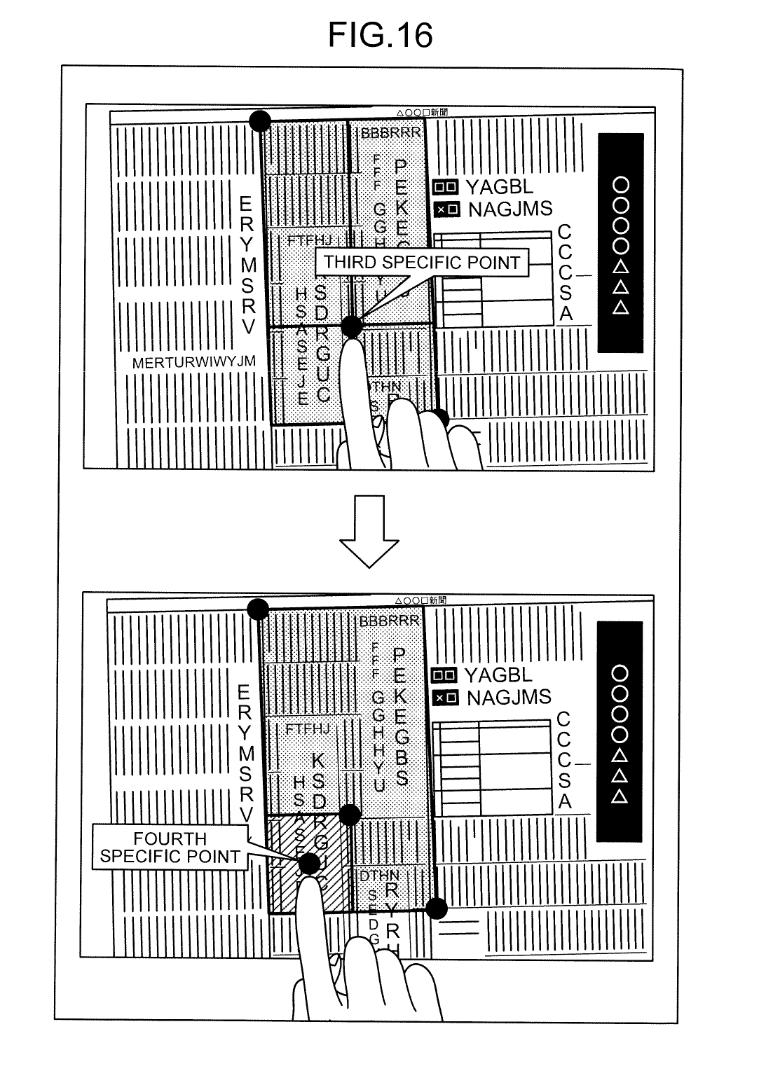

As shown in the upper view in FIG. 15, a first specific point at an upper left end of an area to be cropped is detected in the process performed by the specific-point detecting unit 102b. As shown in the lower view in FIG. 15, a second specific point at a lower right end of the area to be cropped is detected in the process performed by the specific-point detecting unit 102b. As described above, N=2 is satisfied when only a rectangular area to be cropped is specified and the repeated process ends here. If one area to be eliminated is specified, N=4 is satisfied and thus the repeated process continue. FIG. 16 is a view illustrating a case in which a third specific point and a fourth specific point are detected.

As shown in the upper view in FIG. 16, on a third image that is photographed in the repeated process, a third specific point specified by a fingertip is detected in a rectangular area to be cropped with opposing corners at the above-described two specific points in the process performed by the eliminated-area detecting unit 102h. Based on the detected specific point, the area to be cropped can be divided into four areas as shown in FIG. 16. In order to select an area to be eliminated among the four areas, the user further points one of the four areas with his/her fingertip. In other words, as shown in the lower view in FIG. 16, a fourth specific point is detected in a process performed by the eliminated-area detecting unit 102h in a fourth image captured in the repeated process. Accordingly, the area eliminating unit 102j can determine an area (the shaded area in FIG. 16) to be eliminated from the area to be cropped among the four areas.

When the image acquiring unit 102a determines that the predetermined number of points, i.e., N points, are detected (Yes at Step SC7), the skew detecting unit 102d detects a skew of the document by detecting a document edge, etc. from the image based on the image data that is stored by the image acquiring unit 102a in the image-data temporary file 106a, and the image cropping unit 102c creates, as an area to be cropped, a rectangle reflecting the skew, which is detected by the skew detecting unit 102d, with opposing corners at the detected two specific points (Step SC8). When there is an area to be eliminated, the image cropping unit 102c may create an area to be cropped from which the area has been eliminated by the area eliminating unit 102j. Alternatively, the area eliminating unit 102j may eliminate an image of the area to be eliminated from the image cropped in the following process performed by the image cropping unit 102c.

The image cropping unit 102c crops an image of the created area to be cropped from the image data stored by the image acquiring unit 102a in the image-data temporary file 106a (Step SC9). As shown in FIGS. 15 and 16, an area to be cropped in the document is sometimes masked by an indicator and, the whole area to be cropped is sometimes photographed as shown in the lower view in FIG. 15. Thus, the image cropping unit 102c determines image data including no indicator in the area to be cropped and performs the cropping process on the determined image data. As described above, because the user does not have to intentionally position an indicator such that the indicator avoids the document, more natural operability can be provided. When the whole area to be cropped is not photographed in each image, the image cropping unit 102c may composite multiple images to acquire an image to be cropped or, after the indicator is removed by the user from the document, the image acquiring unit 102a may acquire images of the document including no indicator.

The skew correcting unit 102e performs a skew correction based on the skew detected by the skew detecting unit 102d on the image cropped by the image cropping unit 102c as in the same with Step SB 11 (Step SC10). For example, as described above, when the skew detected by the skew detecting unit 102d is θ°, the skew correcting unit 102e performs a skew correction by rotating −θ° with respect to the image, which is cropped by the image cropping unit 102c, such that the skew is eliminated.

The skew correcting unit 102e stores the processed image data on which the skew correction has been performed in the processed-image data file 106b (Step SC11).

The above-described processing is an example of the single-handed processing performed by the overhead scanner device 100 according to the present embodiment. In the above-description, image acquisition by the eliminated-image acquiring unit 102g is not distinguished from image acquisition by the image acquiring unit 102a. However, in the repeated process for the third time or later, a part described as the process performed by the image acquiring unit 102a is, in a narrow sense, performed as the process performed by the eliminated-image acquiring unit 102g.

### 3. Summary of Present Embodiment and Other Embodiments

As explained above, according to the present embodiment, the overhead scanner device 100 controls the image photographing unit 110 to acquire an image of a document including at least an indicator provided by the user, detects two specific points each determined based on the distance from the gravity center of an indicator to the end of the indicator from the acquired image, and crops the acquired image into a rectangle with opposing corners into the two specific points. This allows improvement of the operability of specifying an area to be cropped without requiring any specific tool such as a console or a dedicated pen with which a cursor movement button is operated on a display screen. For example, conventionally, the user temporarily looks away his/her eyes from the document and the scanner device, and looks at the console of the display screen, which causes work interruption, to lead to reduction of production efficiency. The present invention, however, the area to be cropped can be specified without looking away his/her eyes from the document and the scanner device or without contaminating the document with the dedicated pen. Since each specific point is determined based on the distance from a gravity center of an indicator to the end of the indicator, the point specified by a user can be detected with accuracy.

The conventional overhead scanner device is developed in such a manner that the finger tends to be removed because it is rather not to be photographed. However, according to the present embodiment, by actively photographing an object such as the finger together with the document, the object is used for the control of the scanner or the control of the image. In other words, the object such as the finger cannot be read by a scanner such as a flatbed scanner and an ADF (Auto Document Feeder) type scanner. However, according to the present embodiment, the overhead type scanner is used, so that the image of the object can be actively used for detection of an area to be cropped.

According to the present embodiment, the overhead scanner device 100 controls the image photographing unit 110 to acquire, in response to a predetermined acquisition trigger, two images of a document including an indicator provided by a user and two points specified by the indicator are detected from the acquired two images. Accordingly, the user can specify an area to be cropped by using only the single indicator. Particularly when a fingertip is used as an indicator, a user can specify an area to be cropped by an operation with only one of his/her hands.

According to the present embodiment, the overhead scanner device 100 acquires an image of a document including an indicator provided by the user in a rectangle with opposing corners at detected two points, detects the area specified by the indicator in the acquired image, and eliminates the detected area from a cropped image. Accordingly, even when an area that the user desires to crop is not rectangular, a complicated polygon, such as a block shape that is a combination of multiple rectangles, can be specified as an area to be cropped.

According to the present embodiment, the overhead scanner device 100 detects a skin-color portion area from the acquired image to detect the fingertip of the hand being the indicator, and detects the two specific points specified by the fingertips of the hands. This allows high-precision detection of the area to be cropped by accurately detecting the area of the finger of the hand on the image using the skin color.

According to the present embodiment, the overhead scanner device 100 creates a plurality of finger-direction vectors from the gravity center of the hand toward its periphery, and when the relevance indicating the overlapping width of the portion area and a normal vector of a created finger-direction vector is the highest, the end of the finger-direction vector is determined as a fingertip. Thus, the fingertip can be accurately detected based on an assumption that the finger projects from the gravity center of the hand toward the outer periphery of the hand.

According to the present embodiment, the overhead scanner device 100 detects two specific points specified by two sticky notes being the indicators from the acquired image. This allows detection of a rectangle with the two specific points specified by the two sticky notes as opposing corners, as an area to be cropped.

According to the present embodiment, the overhead scanner device 100 detects two specific points specified by two pens being the indicators from the acquired image. This allows detection of a rectangle, as an area to be cropped, with the two specific points specified by the two pens as opposing corners.

According to the present embodiment, the overhead scanner device 100 stores any one or both of the color and the shape of the indicators provided by the user in the storage unit, detects the indicator on the image based on any one or both of the stored color and shape, and detects the two specific points specified by the one or two indicators. Thus, even in the case where the color and the shape of the indicators (for example, fingertips of the hands) are different from each other for each user, the areas of the indicators on the image can be accurately detected through learning of the color and the shape of the indicators, which enables to detect the area to be cropped.

According to the present embodiment, the overhead scanner device 100 detects a skew of the document from the acquired image, crops the image as an area to be cropped to which the skew is reflected, rotates the cropped image so as to eliminate the skew, and corrects the skew. With this feature, by correcting the skew after the skewed area is cropped without any change thereto, the processing speed can be improved and waste of the resources can be eliminated.

The embodiment of the present invention is explained above. However, the present invention may be implemented in various different embodiments other than the embodiment described above within a technical scope described in claims. For example, the same kinds of indicators are used in the embodiment. However, a combination may be used among indicators such as a fingertip of a user's hand, a sticky note, a pen and so on.

As the embodiment, an example in which the overhead scanner device 100 performs the processing as a standalone apparatus is explained. However, the overhead scanner device 100 can be configured to perform processes in response to request from a client terminal which has a housing separate from the overhead scanner device 100 and return the process results to the client terminal. All the automatic processes explained in the present embodiment can be, entirely or partially, carried out manually. Similarly, all the manual processes explained in the present embodiment can be, entirely or partially, carried out automatically by a known method. The process procedures, the control procedures, specific names, information including registration data for each process, display example, and database construction, mentioned in the description and drawings can be changed as required unless otherwise specified.

The constituent elements of the overhead scanner device 100 are merely conceptual and may not necessarily physically resemble the structures shown in the drawings. For example, the process functions performed by each device of the overhead scanner device 100, especially the each process function performed by the control unit 102, can be entirely or partially realized by CPU and a computer program executed by the CPU or by a hardware using wired logic. The computer program, recorded on a recording medium to be described later, can be mechanically read by the overhead scanner device 100 as the situation demands. In other words, the storage unit 106 such as read-only memory (ROM) or hard disk drive (HDD) stores the computer program for performing various processes. The computer program is first loaded to the random access memory (RAM), and forms the control unit in collaboration with the CPU. Alternatively, the computer program can be stored in any application program server connected to the overhead scanner device 100 via the network, and can be fully or partially loaded as the situation demands.

The computer program may be stored in a computer-readable recording medium, or may be structured as a program product. Here, the “recording medium” includes any “portable physical medium” such as a memory card, a USB (Universal Serial Bus) memory, an SD (Secure Digital) card, a flexible disk, a magnetic optical disk, a ROM, an EPROM (Erasable Programmable Read Only Memory), an EEPROM (Electronically Erasable and Programmable Read Only Memory), a CD-ROM (Compact Disk Read Only Memory), an MO (Magneto-Optical disk), a DVD (Digital Versatile Disk), and a Blue-ray Disc. Computer program refers to a data processing method written in any computer language and written method, and can have software codes and binary codes in any format. The computer program can be a dispersed form in the form of a plurality of modules or libraries, or can perform various functions in collaboration with a different program such as the OS. Any known configuration in the each device according to the embodiment can be used for reading the recording medium. Similarly, any known process procedure for reading or installing the computer program can be used.

Various databases and the like (the image-data temporary file 106a, the processed-image data file 106b, and the indicator file 106c) stored in the storage unit 106 are storage means such as a memory device such as a RAM or a ROM, a fixed disk device such as a HDD, a flexible disk, and an optical disk, and stores therein various programs, tables, and databases used for providing various processing.

The overhead scanner device 100 may be structured as an information processing apparatus such as known personal computers or workstations. Furthermore, the information processing apparatus may be structured by connecting any peripheral devices. The overhead scanner device 100 may be realized by the information processing apparatus in which software (including program or data) for executing the method according to the present invention is implemented. The distribution and integration of the device are not limited to those illustrated in the figures. The device as a whole or in parts can be functionally or physically distributed or integrated in an arbitrary unit according to various attachments or how the device is to be used. That is, any embodiments described above can be combined when implemented, or the embodiments can selectively be implemented.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An overhead scanner device comprising:
an image photographing unit; and
a control unit, wherein
the control unit includes:
an image acquiring unit that controls the image photographing unit to acquire an image of a document including at least an indicator provided by a user;
a specific-point detecting unit that detects two specific points each determined based on the distance from the gravity center of an indicator to the end of the indicator, from the image acquired by the image acquiring unit; and
an image cropping unit that crops the image acquired by the image acquiring unit into a rectangle with opposing corners at the two points detected by the specific-point detecting unit.

2. The overhead scanner device according to claim 1, wherein
the image acquiring unit controls the image photographing unit to acquire, in response to a predetermined acquisition trigger, two images of a document including an indicator provided by a user, and
the specific-point detecting unit detects two points specified by the indicator from the two images acquired by the image acquiring unit.

3. The overhead scanner device according to claim 1, wherein the control unit further includes:
an eliminated-image acquiring unit that acquires an image of a document including an indicator that is provided by the user in a rectangle with opposing corners at two specific points detected by the specific-point detecting unit;
an eliminated-area detecting unit that detects an area specified by the indicator from the image that is acquired by the eliminated-image acquiring unit; and
an area eliminating unit that eliminates the area that is detected by the eliminated-area detecting unit from the image cropped by the image cropping unit.

4. The overhead scanner device according to claim 1, wherein the specific-point detecting unit detects a skin-color portion area from the image acquired by the image acquiring unit to detect the fingertip of the hand being the indicator, and detects the two points specified by the indicator.

5. The overhead scanner device according to claim 4, wherein the specific-point detecting unit creates a plurality of finger-direction vectors directed from the gravity center of the hand toward its periphery, and determines as the fingertip an end of the finger-direction vector whose normal vector is overlapped with the portion area in width closest to a predetermined value.

6. The overhead scanner device according to claim 1, wherein
the indicator is a sticky note, and
the specific-point detecting unit detects the two points specified by the two sticky notes being the indicators, from the image acquired by the image acquiring unit.

7. The overhead scanner device according to claim 1, wherein the indicator is a pen, and the specific-point detecting unit detects the two points specified by the two pens being the indicators, from the image acquired by the image acquiring unit.

8. The overhead scanner device according to claim 1, further comprising a storage unit, wherein
the control unit further includes an indicator storing unit that stores any one or both of a color and a shape of the indicator provided by the user in the storage unit, and
the specific-point detecting unit detects the indicator on the image acquired by the image acquiring unit based on any one or both of the color and the shape stored in the storage unit by the indicator storing unit, and detects the two points specified by the one or more indicators.

9. The overhead scanner device according to claim 1, wherein the control unit further includes:
a skew detecting unit that detects a skew of the document from the image acquired by the image acquiring unit; and
a skew correcting unit that corrects the skew of the image cropped by the image cropping unit using the skew detected by the skew detecting unit.

10. An image processing method executed by an overhead scanner device including an image photographing unit, and a control unit, wherein
the method executed by the control unit comprises:
an image acquiring step of controlling the image photographing unit to acquire an image of a document including at least an indicator provided by a user;
a specific-point detecting step of detecting two specific points each determined based on the distance from the gravity center of an indicator to the end of the indicator, from the image acquired at the image acquiring step; and
an image cropping step of cropping the image acquired at the image acquiring step into a rectangle with opposing corners at the two points detected at the specific-point detecting step.

11. A computer-readable recording medium that stores therein a computer program for an overhead scanner device including an image photographing unit, and a control unit, the computer program causing the control unit to execute:
an image acquiring step of controlling the image photographing unit to acquire an image of a document including at least an indicator provided by a user;
a specific-point detecting step of detecting two specific points each determined based on the distance from the gravity center of an indicator to the end of the indicator, from the image acquired at the image acquiring step; and
an image cropping step of cropping the image acquired at the image acquiring step into a rectangle with opposing corners at the two points detected at the specific-point detecting step.
